(19) United States
(12) Patent Application Publication
(10) Pub. No.: US 2025/0021807 A1
(43) Pub. Date: Jan. 16, 2025

(54) Neuromorphic Emulation Constructor AI for Precise Computational Emulation of Human Brain Architecture

(71) Applicant: Brain Electrophysiology Laboratory Company, LLC, Eugene, OR (US)

(72) Inventors: Don M. Tucker, Eugene, OR (US); Phan Luu, Eugene, OR (US)

(21) Appl. No.: 18/813,226

(22) Filed: Aug. 23, 2024

(51) Int. Cl. G06N 3/063

(52) U.S. Cl. CPC G06N 3/063

(57) ABSTRACT

The Neuromorphic Emulation Constructor AI (NECA) is an artificial intelligence technology for building a Personal Neuromorphic Emulation (PNE), a detailed model of an individual's brain that is anatomically correct, capable of learning and plasticity, and able to emulate the person's brain electrical activity and behavior. The NECA accesses the neuroscience literature through automated search and acquisition technologies such as Google Scholar, and it assembles the knowledge of the brain's structure and function in ways that specify how to build and test the PNE.

### BACKGROUND OF THE INVENTION

There is considerably interest (reflected by a European initiative and a NATO program) on the construction of human digital twins. The field of artificial intelligence (AI) is highly relevant to constructing a digital twin, particularly with its novel neural network architectures and machine learning. However, achieving a detailed and accurate emulation of the human brain remains a complex challenge. A digital twin that only operates as an LLM would not have the full complexity of human neuropsychological emulation required for an adequate emulation of the human mind, which is according to certain neuropsychological theories identical to the human brain (Tucker & Luu, Cognition & Neural Development, Oxford Press, 2012).

Existing systems lack the capacity to comprehensively model the intricacies of human cerebral architecture. Recent advancements in neuromorphic computing and the theory of active inference suggest that it is possible to create a computational emulation of a human brain, capturing the essential features that define individual identity and subjective experience (Feasibility of a Personal Neuromorphic Emulation doi: 10.20944/preprints202407.1147). An essential component is the achievement of Bayesian super-resolution that the PNE allows through its capacity to predict the neural, and therefore electrical, activity of the human brain in very high resolution. Necessary computational capacities are now emerging in neuromorphic quantum computing, presenting an attractive preferred embodiment for the construction of the PNE. The present invention draws on these capacities to create a Neuromorphic Emulation Constructor AI (NECA) designed to construct precise computational models of an individual human brain by leveraging extensive scientific literature, data, and continuous very-high-definition electroencephalography (vhdEEG) monitoring.

### SUMMARY OF THE INVENTION

The present invention relates to a Neuromorphic Emulation Constructor AI (NECA) capable of constructing an exact computational emulation of a person's brain. The NECA is designed to access scientific literature through search engines like Google Scholar, analyze and process scientific articles, and provide guidance for the construction of a multi-level model of human cerebral architecture. Additionally, the system incorporates 24/7 vert high-definition electroencephalography (vhdEEG) monitoring with source localization (augmented by the parallel invention of synergistic Bayesian super-resolution for the Bayesian Adaptive Neural Interface) to enhance the accuracy and fidelity of the Personal Neuromorphic Emulation (PNE). Finally, a companion invention, the Neuromorphic Artificial Neural Network Assistant (NANNA) is a virtual personal assistant that not only completes routine tasks for the person in daily life, but also collects a detailed record of the person's experiences and behavior to allow the PNE to be trained (with the NECA's help) to achieve a precise emulation of the person's experience and behavior as well as her neural activity as captured.

### DESCRIPTION OF THE DRAWING

FIG. 1 illustrates the overall design and primary information processing flow for the NECA.

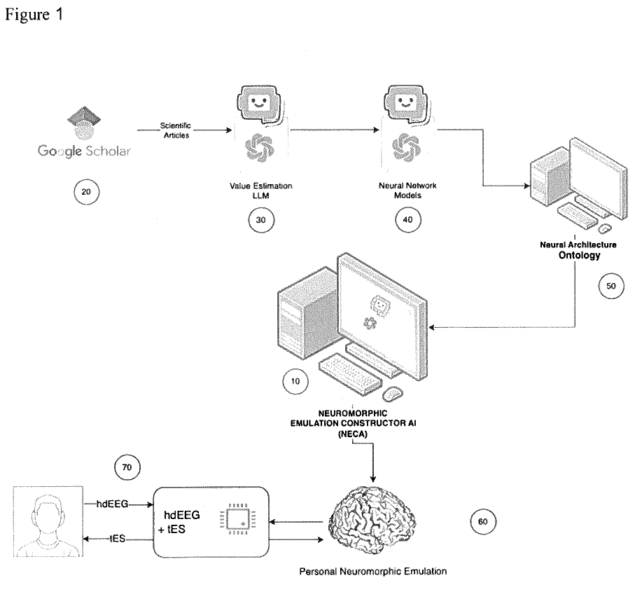

10 The NECA creates the PNE (60) on the basis of scientific evidence on human neural architecture.
20 An interface to Google Scholar uses keywords to access the scientific literature for evidence on the anatomy and function of the human brain, informed by the animal neuroscience literature as well.
30 The relevance of each scientific paper is judged by the value estimator AI LLM on the basis of the NECA's progress in constructing the PNE (and what information is currently relevant).
40 The new scientific evidence is organized in relation to various levels of information communication in the brain, specifically in relation to the levels of network organization (columnar, local regional, long distance networks).
50 These levels of information (10 through 40) are organized in relation to an ontology of the human brain's anatomy and function.
60 The output of the NECA is the PNE, the emulation of an individual's brain/mind.
70 The PNE is trained in relation to its ability to predict both the behavior and the electrophysiology (hdEEG) of the person. In addition, hdtES allows experimentation with two-way interface with the electrical fields of the person's brain.

### DETAILED DESCRIPTION OF THE INVENTION

### Foundational Principles

The invention leverages several foundational principles and recent advancements to achieve its objectives:
Distributed Representation and Neurodevelopmental Identity:
The memory and cognitive functions in both biological brains and artificial neural networks are implemented through distributed representations of connection weights among neurons. These representations are dynamic, continuously evolving through learning and experience.
Informatic Basis of Organisms:
The processes of living organisms, including their cognitive functions, can be described in terms of information theory. This includes the minimization of free energy and maintaining a non-equilibrium steady state (NESS), which are essential for self-organizing systems.
High-Resolution Neuroinformatic Data:
By employing hdEEG and source localization techniques, the system can gather high-resolution data on an individual's brain activity, capturing the intricate details of their neural connections and functional states.
Active Inference and Self-Regulation:
The NECA uses active inference to model and predict the brain's responses, continuously updating the PNE based on real-time data. This allows the emulation to adapt and self-regulate, closely mimicking the individual's cognitive processes.
Neuroinformatic Replication:
The combined capabilities of PNE and NECA enable the creation of a durable neuroinformatic replication of an individual's brain, preserving their subjective self and cognitive functions in a computational form.
The Subjective Turing Test: If the PNE is trained to precisely emulate the person's neural activity, experience, and behavior, then the interface of the person's brain with the PNE (through two-way communication with the hdEEG/tES interface) allows the person to subjectively evaluate the quality of the emulation.

### Feasibility Analysis

The paper by Tucker and Luu (2024; doi: 10.20944/preprints202407.1147.v1) supports the feasibility of this approach, highlighting the theoretical and practical advancements that make it possible to construct an accurate PNE. The principles of active inference, neurodevelopmental identity, and the informatic basis of organisms provide a robust framework for achieving a high-fidelity emulation of the human brain.

### System Overview

The NECA is constructed with several AI components, integrated within the inventors' workflow management and database software, the Forward Looking Operations Workflow (FLOW; bel.company). The preferred embodiment builds the individual's brain architecture model for the PNE, starting with the individual neuroimaging processing provided by the inventor's Sourcerer MRI modeling (head tissue segmentation, cortical surface extraction, electrical conductivity specification) and hdEEG localization software. Access to the scientific literature in the preferred embodiment is provided by Google Scholar. Access to LLMs is provided by direct management in the case of LlaMa 3 and through the Developer's API in the case of OpenAI ChatGPT 4o.

### System Functions

The NECA is a sophisticated AI system designed to perform the following key functions:
Data Acquisition: The system accesses scientific literature databases such as Google Scholar to gather relevant articles on human brain architecture.
Information Processing: Advanced natural language processing (NLP) techniques are employed to analyze and extract pertinent information from the literature.
Multi-Level Architecture Construction: The NECA utilizes the extracted information to guide the construction of a detailed, multi-level emulation of the human brain, including neural connections, functional regions, and synaptic dynamics captured within computational models of cortical columns. The implementation of neocortical processing models of active inference in relation to cortical column models allows for efficient high-level emulation.
Continuous Monitoring: The system includes 24/7 high-definition electroencephalography (hdEEG) monitoring to provide real-time data on brain activity and enhance the emulation accuracy. Parameters are 280 scalp and head surface channels, acquisition rates up to 1000 samples/second, and cortical source localization up to 9600 dipoles in the inventors' Sourcerer software.

### Data Acquisition Module

Search Engine Integration: The NECA integrates with search engines like Google Scholar using APIs to retrieve scientific articles.
Relevance Filtering: An AI-based filtering mechanism assesses the relevance of the retrieved articles based on keywords, citation count, and publication date.
Data Storage: Relevant articles and extracted data are stored in a structured database for further processing.

### Information Processing Module

Natural Language Processing (NLP): The NECA employs state-of-the-art NLP techniques to comprehend and summarize scientific texts.
Knowledge Extraction: Key information related to brain architecture, such as neural pathways, functional regions, and synaptic properties, is extracted.
Ontology Creation: An ontology is created to organize the extracted knowledge into a coherent structure that mirrors the hierarchical organization of the human brain.
A fundamental principle is that, in brains and machines, neural connectivity implies function. Therefore the ontology is founded on the detailed anatomy of an individual brain, when then can be functionally described by general principles of human brain function.

### Multi-Level Architecture Construction Module

Neural Network Emulation: The NECA constructs a detailed emulation of neural networks, incorporating data on neuron types, connectivity, and synaptic dynamics.
Functional Region Modeling: Specific brain regions are modeled based on functional roles and interactions, using data from the literature.
Synaptic Plasticity Simulation: The emulation includes dynamic models of synaptic plasticity to capture learning and memory processes.
Neuromorphic Quantum Computing: The very high computational requirements required to emulate the human brain exactly are provided by the preferred embodiment in the emerging technology of neuromorphic quantum computers, specifically designed to emulation neuromorphic operations.
   Continuous Monitoring with hdEEG
High-Definition Electroencephalography (hdEEG): The NECA system includes hdEEG monitoring with source localization to provide high-resolution data on brain activity.
Source Localization: The system computes the individual's cortical activity at a resolution of a few millimeters with 9600 source dipoles, sampled at a high rate (500 samples or even 1000 samples per second).
Long-Term Monitoring: Continuous monitoring over months or years allows for detailed tracking of brain activity and enhances the fidelity of the PNE.
Extension to Bayesian Super-Resolution: The related invention of Bayesian super-resolution by Tucker, Luu, and Shusterman draws on the predictive model of an initial PNE to predict the electrical fields of small patches of cortical columns, which can be trained with the native resolution of hdEEG to achieve very high definition EEG (vhdEEG) that is then available for further training with the NECA system.

### Personal Neuromorphic Emulation (PNE)

Individualized Modeling: The NECA uses personal brain data (e.g., MRI scans, neurophysiological recordings, hdEEG data) to tailor the emulation to a specific individual.
Validation and Testing: The PNE undergoes rigorous validation and testing to ensure its accuracy and fidelity in replicating the individual's brain functions. The NECA provides the plasticity control over the PNE to adapt its architecture to achieve a precise emulation/prediction of the person's regional neuroelectric fields in order to train and validate the PNE's effective emulation of the person's brain.

### CONCLUSION

The Neuromorphic Emulation Constructor AI presents a novel approach to constructing precise computational models of individual human brains. By leveraging scientific literature, advanced AI techniques, continuous high-definition electroencephalography (hdEEG) monitoring, and the massively parallel computational operations of neuromorphic quantum computers, the NECA offers a pathway to creating detailed and accurate brain emulations, paving the way for significant advancements in neuroscience, personalized medicine, and AI research. The PNE and NECA together offer a promising pathway to achieving a computational model that can preserve and extend individual human cognition and identity.

The invention claimed is:

1. A Neuromorphic Emulation Constructor AI (NECA) system comprising:
A data acquisition module for accessing and retrieving scientific literature on human brain architecture;
An information processing module for analyzing and extracting key information from the retrieved literature using natural language processing techniques;
A multi-level architecture construction module for building a detailed computational emulation of the human brain based on the extracted information;
A continuous monitoring module for 24/7 high-definition electroencephalography (hdEEG) to enhance the emulation accuracy.

2. The system of claim 1, wherein the data acquisition module integrates with search engines such as Google Scholar to retrieve relevant scientific articles.

3. The system of claim 1, wherein the information processing module includes an AI-based filtering mechanism to assess the relevance of retrieved articles.

4. The system of claim 1, wherein the multi-level architecture construction module includes models for neural networks, functional brain regions, and synaptic plasticity.

5. The system of claim 1, further comprising a Personal Neuromorphic Emulation (PNE) module for creating individualized brain models based on personal brain data.

6. The system of claim 1, wherein the continuous monitoring module includes high-definition electroencephalography (hdEEG) with source localization to provide high-resolution data on brain activity.

7. The system of claim 6, wherein the source localization is computed at a resolution of a few millimeters with 9600 source dipoles, sampled at 1000 samples per second.

8. The system of claim 6, wherein the continuous monitoring is conducted over a period of months or years to enhance the fidelity of the emulation.

9. The system of claim 6, wherein the requisite computational complexity is achieved by a neuromorphic quantum computer, designed for efficient representation of the highly parallel operation of human interconnected neural networks.

10. The system of claim 1, wherein the PNE module validates and tests the emulation to ensure its accuracy and fidelity in replicating the individual's brain functions.

11. The system of claim 1, in which the constraints of hdEEG are enhanced to a higher resolution with the method of Bayesian super-resolution.
